(19) United States
(12) Patent Application Publication
(10) Pub. No.: US 2007/0172093 A1
(43) Pub. Date: Jul. 26, 2007

(54) Copper foil wire for loudspeaker, and loudspeaker employing the loudspeaker copper foil wire

(75) Inventor: Tamie Oyanagi, Osaka (JP)

Correspondence Address: STEPTOE & JOHNSON LLP, 1330 CONNECTICUT AVE., NW, WASHINGTON, DC, 20036, US

(73) Assignee: Matsushita Electrial Industrial Co., Ltd., Osaka (JP)

(21) Appl. No.: 10/589,612

(22) PCT Filed: Jun. 30, 2005
(86) PCT No.: PCT/JP05/12085

§ 371 Date: Aug. 16, 2006

(30) Foreign Application Priority Data
Jul. 9, 2004 (JP) 2004-202518

(51) Int. Cl. H04R 9/06

(52) U.S. Cl. 381/409; 381/400

(57) ABSTRACT

A loudspeaker copper foil wire according to the present invention is excellent in flame resistance, moisture resistance, corrosion resistance, hopping resistance and soldering property, and capable of suppressing emanation of smell during a soldering operation. In the present invention, a copper foil wire body is impregnated or coated with a flame resistant wax prepared by blending 5 wt % to 50 wt % of a halogen-free aromatic condensation phosphoric ester flame retardant in a petroleum paraffin wax base.

### TECHNICAL FIELD

The present invention relates to a copper foil wire for a loudspeaker, and a loudspeaker employing the loudspeaker copper foil wire.

### BACKGROUND ART

FIG. 2 is a side sectional view illustrating the construction of a prior art loudspeaker.

In FIG. 2, a magnetic circuit 1 includes a lower plate 1a having a center pole portion, a ring-shaped magnet 1b and a ring-shaped upper plate 1c, which are stacked one on another and bonded to one another as shown in FIG. 2. An annular magnetic gap is defined between a peripheral surface of the center pole portion of the lower plate 1a and an inner peripheral surface of the ring-shaped upper plate 1c.

A frame 2 is mounted on the top of the magnetic circuit 1. A voice coil 6 is wound around a voice coil bobbin 4 fitted in the magnetic gap of the magnetic circuit 1 in a movable manner. An inner rim of a vibration diaphragm 3 is connected to the voice coil bobbin 4, and an outer rim of the vibration diaphragm 3 is connected to the frame 2. A terminal plate 5 serving as an external connection terminal is attached to the frame 2.

A pair of copper foil wires 7 are connected to opposite ends of the voice coil 6 at one-side ends thereof, and connected to the terminal plate 5 at the other-side ends thereof. As shown in detail in FIG. 3, the copper foil wires 7 each include a plurality of core threads 8 each wrapped with a copper foil 9 and braided or stranded. The copper foil wires are each generally called “gold wire” or “cotton wire”, though there are some variations in construction.

The loudspeaker is generally adapted to reproduce a sound by vertically vibrating the voice coil 6 and vibrating the vibration diaphragm 3 by the vibration of the voice coil 6 and output the reproduced sound when a sound signal is inputted to the terminal plate 5 serving as the external connection terminal.

In recent years, there has been an increasing tendency toward increase in an input load to be applied to the loudspeaker. However, when a greater input load is applied to the loudspeaker, a so-called hopping phenomenon occurs in which the copper foil wires 7 are vibrated by the vibration of the vibration diaphragm 3. The copper foil wires 7 are liable to collide with the vibration diaphragm 3 due to the hopping phenomenon, resulting in noises and, in an extreme case, breakage. Therefore, copper foil wires impregnated with a wax are used as the copper foil wires 7, but problematic in that the copper foil wires 7 are liable to generate heat due to the greater input load to the loudspeaker.

To cope with the heat generation of the copper foil wires due to the greater input load, a loudspeaker copper foil wire impregnated with a flame resistant wax rather than with the prior art wax for improvement of the flame resistance has conventionally been proposed (see, for example, JP10-101938A).

With the rapidly increasing tendency toward the greater input load to the loudspeaker, however, the conventional measures for the flame resistance are not sufficient. Therefore, the copper foil wires suffer from the heat generation due to the greater input load thereby to be made brittle.

The wax for the prior art loudspeaker copper foil wires contains a halogen-containing liquid phosphoric ester such as a bromine-containing triaryl phosphoric ester as the flame retardant and, optionally, an inorganic flame retardant and an organic tin compound as a stabilizer and, therefore, has a poorer flame resistance. In order to ensure a flame resistance equivalent to the UL Standard 94V-1, the flame retardant should be blended in a weight ratio of not smaller than 100% in the wax. Therefore, the effect of the wax is reduced, so that the copper foil wires suffer from deterioration of moisture resistance and corrosion resistance, generation of noises and breakage due to the hopping phenomenon, emanation of smell during a soldering operation, and deterioration of soldering property.

### DISCLOSURE OF THE INVENTION

### Problems to be Solved by the Invention

In view of the aforesaid problems, it is an object of the present invention to provide a loudspeaker copper foil wire which includes a copper foil wire body impregnated or coated with a flame resistant wax prepared by blending 5 wt % to 50 wt % of a halogen-free aromatic condensation phosphoric ester flame retardant in a petroleum paraffin wax, and is excellent in flame resistance, moisture resistance, corrosion resistance, hopping resistance and soldering property and capable of suppressing emanation of smell during a soldering operation, and to provide a loudspeaker employing the copper foil wire.

### MEANS FOR SOLVING THE PROBLEMS

A loudspeaker copper foil wire according to claim 1 of the present invention comprises a copper foil wire body impregnated or coated with a flame resistant wax, the flame resistant wax comprising a petroleum paraffin wax and 5 wt % to 50 wt % of a halogen-free aromatic condensation phosphoric ester flame retardant.

According to claim 2 of the present invention, the halogen-free aromatic condensation phosphoric ester flame retardant has a melting point of 80° C. to 140° C. and a decomposition temperature of not lower than 250° C. in the loudspeaker copper foil wire of claim 1.

According to claim 3 of the present invention, the copper foil wire body includes a plurality of core threads each wrapped with a copper foil and braided or stranded in the loudspeaker copper foil wire of claim 1 or 2.

A loudspeaker according to claim 4 of the present invention comprises a magnetic circuit, a frame mounted on the magnetic circuit, a voice coil fitted in a magnetic gap of the magnetic circuit, a vibration diaphragm having an inner rim connected to the voice coil and an outer rim connected to the frame, an external connection terminal attached to the frame, and a pair of copper foil wires connected to opposite ends of the voice coil at one-side ends thereof and connected to the external connection terminal at the other-side ends thereof, wherein the copper foil wires each comprise the loudspeaker copper foil wire of any of claims 1 to 3.

### EFFECTS OF THE INVENTION

According to the present invention, the copper foil wire has a flame resistance not lower than the UL Standard 94V-2 and a sufficient effect provided by the addition of the wax, and yet has a sufficient flexibility. Further, the copper foil wire is excellent in moisture resistance, corrosion resistance, hopping resistance and soldering property, and capable of suppressing emanation of smell during a soldering operation.

### BRIEF DESCRIPTION OF THE DRAWINGS

FIG. 1 is a sectional view illustrating the construction of a loudspeaker copper foil wire according to an embodiment of the present invention;

FIG. 2 is a side sectional view illustrating the construction of a prior art loudspeaker; and

FIG. 3 is a sectional view illustrating the construction of a prior art copper foil wire.

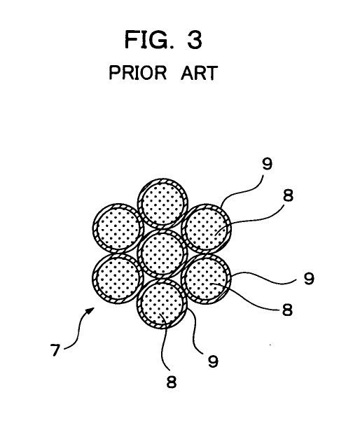

### BEST MODE FOR IMPLEMENTING THE INVENTION

A loudspeaker copper foil wire according to an embodiment of the present invention will hereinafter be described. Components corresponding to those of the prior art loudspeaker copper foil wire and the prior art loudspeaker will be denoted by the same reference characters as those employed in the description of the prior art, and will not be described in detail.

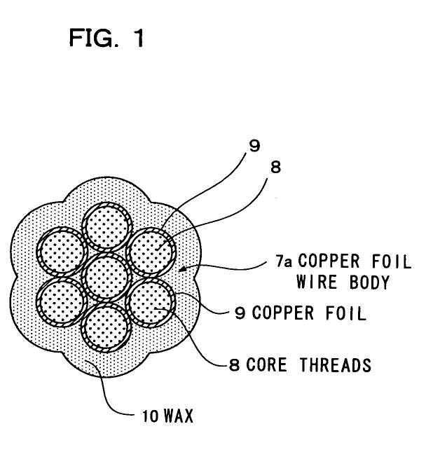

FIG. 1 is a sectional view illustrating the construction of the loudspeaker copper foil wire (hereinafter referred to simply as “copper foil wire”) according to the embodiment.

In FIG. 1, core threads 8 are cotton threads or heat resistant chemical fiber threads (e.g., threads of aromatic polyamide fibers). The core threads 8 are each wrapped with a copper foil 9 to form a single string, and a plurality of such strings are braided or stranded to form a copper foil wire body 7a. A copper foil wire 7 is sheathed with a wax layer 10 by immersing the copper foil wire body 7a in a melted wax. Alternatively, the wax layer 10 may be formed on a surface of the copper foil wire body 7a through a coating process.

Next, specific examples will be described.

First, waxes A, B, C as listed in Table 1 were prepared and melted, and copper foil wire bodies 7a were respectively immersed in the melted waxes, whereby wax layers 10 were formed on surfaces of the respective copper foil wire bodies as shown in FIG. 1. Thus, copper foil wires A, B, C respectively impregnated with the waxes 10 were produced.

TABLE 1

| | Prior art copper | Copper | Copper | Copper |
|---|---|---|---|---|
| | foil wire | foil wire A | foil wire B | foil wire C |
| Item (unit) | Prior art wax | Wax A | Wax B | Wax C |
| Wax base (parts) | 100 | 100 | 100 | 100 |
| Type of used flame retarder | Halogen-containing | Aromatic condensation phosphate | | |
| (Chemical name) | flame retarder | | | |
| Flame retarder (parts) | 100 | 5 | 10 | 15 |
| Melting point of blended | 84-86 | 84-86 | 84-86 | 84-86 |
| wax (° C.) | | | | |
| Melting point of flame | — | 95 | 95 | 95 |
| retarder (° C.) | | | | |
| Bending strength (Number of | 21000-23000 | 23000-25000 | 23000-25000 | 23000-25000 |
| times) of copper foil wire | | | | |
| Corrosion resistance 1 | Excellent | Excellent | Excellent | Excellent |
| of copper foil wire | | | | |
| Corrosion resistance 2 | Excellent | Excellent | Excellent | Excellent |
| of copper foil wire | | | | |
| Soldering property 1 | Excellent | Excellent | Excellent | Excellent |
| of copper foil wire | | | | |
| Soldering property 2 | Excellent | Excellent | Excellent | Excellent |
| of copper foil wire | | | | |
| Flame resistance (UL-94) | V-2 | V-2 | V-1 | V-0 |
| of copper foil wire | | | | |

That is, the wax A was prepared by blending 5 wt % of a halogen-free aromatic condensation phosphoric ester flame retardant in a wax base. The wax B was prepared by blending 10 wt % of the halogen-free aromatic condensation phosphoric ester flame retardant in the wax base. The wax C was prepared by blending 15 wt % of the halogen-free aromatic condensation phosphoric ester flame retardant in the wax base.

A prior art wax was prepared by blending 100 wt % of a halogen-containing flame retardant, 5 wt % of an inorganic flame retardant, 5 wt % of a synthetic resin and 2 wt % of a stabilizer in the wax base.

More specifically, a petroleum wax base (available under a product name of WAXREX 2480 or 2470 from Exxon Mobile Inc.) having a melting point of about 90° C. was melted at a temperature of about 190° C., and an aromatic condensation phosphoric ester flame retardant (a product available under a product number of PX-200 from Daihachi Chemical Industry Co., Ltd. in this embodiment) having a melting point of 80° C. to 140° C. and a decomposition temperature of not lower than 250° C. was blended in the wax base in weight ratios shown in Table 1. Thus, the waxes A, B, C were prepared. Then, the copper foil wire bodies 7a were respectively immersed in the waxes A, B, C. Thus, the copper foil wires A, B, C were produced.

The Daihachi Chemical Industry's product PX-200 is a white powdery or particulate substance represented by the following chemical formula. In the present invention, the powdery product was used. The product has a phosphorus content of 9.0, a melting point of 92° C. and a flash point of 308° C.
[OC₆H₃(CH₃)₂]₂P(O)OC₆H₄OP(O) [OC₆H₃(CH₃)₂]₂ Chemical formula 1

It is needless to say that the aromatic condensation phosphoric ester is not limited to the Daihachi Chemical Industry's product PX-200. Although the aromatic condensation phosphoric ester is also available in a liquid form, PX-200 in a powdery or particulate form is free from separation from the wax, unlike the liquid aromatic condensation phosphoric ester, when the loudspeaker copper foil wire is impregnated with the wax prepared by mixing the phosphoric ester with the wax base, and more contributable to suppression of the hopping phenomenon of the loudspeaker copper foil wire.

It is needless to say that the wax base is not limited to Exxon Mobile's WAXREX 2480 or 2470.

When the copper foil wire bodies 7a were taken out of the waxes, the copper foil wire bodies 7a were each passed through a dice for prevention of uneven coating with the waxes. Thus, the copper foil wires A, B, C respectively coated with the flame resistant waxes were produced.

Tests for flexural strength, corrosion resistance, soldering property and flame resistance were performed on each of the copper foil wires A, B, C and the prior art copper foil wire. The results are shown in Table 1. It is noted that the copper foil wire bodies herein used were each produced by braiding 12 core threads.

In Table 1, “Flexural strength of copper foil wire” was determined as the number of times of bending repeated until the electrical continuity of the copper foil wire was lost. “Corrosion resistance 1 of copper foil wire” was determined by visually inspecting the state of the copper foil wire after the copper foil wire was allowed to stand in an 85° C. atmosphere for 500 hours. “Corrosion resistance 2 of copper foil wire” was determined by visually inspecting the state of the copper foil wire after the copper foil wire was allowed to stand in a 55° C. and 95% RH (reserve shutdown) atmosphere for 1000 hours.

“Soldering property 1 of copper foil wire” was determined by visually inspecting the state of a portion of the copper foil wire soldered after the copper foil wire was allowed to stand in the 85° C. atmosphere for 500 hours. “Soldering property 2 of copper foil wire” was determined by visually inspecting the state of a portion of the copper foil wire soldered after the copper foil wire was allowed to stand in the 55° C. and 95% RH atmosphere for 1000 hours.

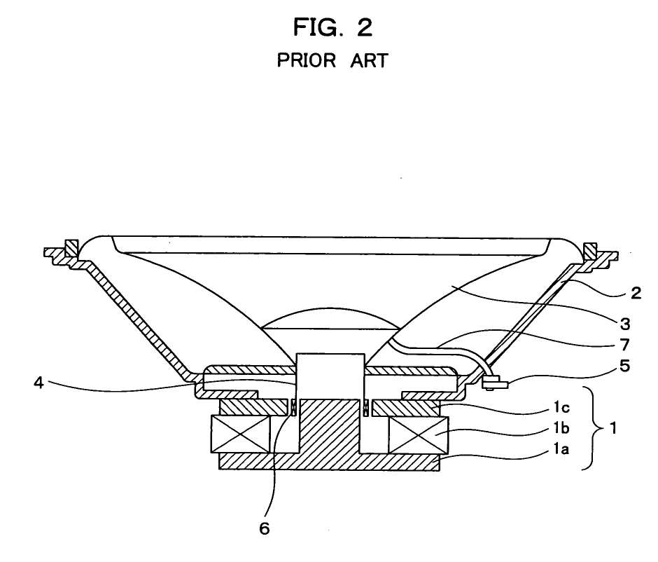

By employing the copper foil wires A, B, C impregnated with the respective flame resistant waxes, loudspeakers each having a construction as shown in FIG. 2 with a diameter of 16 cm were produced. As a comparative example, a loudspeaker was produced in substantially the same manner by employing the prior art copper foil wire impregnated with the flame resistant wax prepared by blending the halogen-containing flame retardant, the inorganic flame retardant and the stabilizer in the wax base. The loudspeakers incorporating the copper foil wires A, B, C and the prior art copper foil wire were each checked for the hopping phenomenon before breakage of the copper foil wires by application of input loads. The results are shown in Table 2.

TABLE 2

| | Input load | | | | | | |
|---|---|---|---|---|---|---|---|
| | 10 W | 20 W | 30 W | 40 W | 50 W | 55 W | 60 W |
| Prior art copper | ◯ | ◯ | ◯ | ◯ | ◯ | X | X |
| foil wire | | | | | | | |
| Copper foil wire A | ◯ | ◯ | ◯ | ◯ | ◯ | ◯ | X |
| Copper foil wire B | ◯ | ◯ | ◯ | ◯ | ◯ | ◯ | X |
| Copper foil wire C | ◯ | ◯ | ◯ | ◯ | ◯ | ◯ | X |

As apparent from the results, the loudspeaker copper foil wires respectively impregnated with the waxes A, B, C according to this embodiment were more excellent in flexural strength than the prior art copper foil wire, and equivalent in corrosion resistance and soldering property to the prior art. Further, the loudspeaker copper foil wires each had a flame resistance equivalent to or higher than that of the prior art copper foil wire depending on the amount of the blended flame retardant. Thus, a flame resistance not lower than the UL Standard 94V-2 was achieved. In addition, the loudspeaker copper foil wires were free from the hopping phenomenon when an input load of not higher than 55 W was applied and, hence, had more excellent hopping resistance than the prior art copper foil wire.

The loudspeaker copper foil wires according to this embodiment require a smaller amount of the flame retardant as compared with a case where the prior art halogen-containing flame retardant is employed, thereby enjoying the effect of the wax. Thus, the loudspeaker copper foil wires are excellent in moisture resistance, corrosion resistance, hopping resistance and soldering property, and capable of suppressing emanation of smell during a soldering operation. Without the use of the inorganic flame retardant and the stabilizer, the loudspeaker copper foil wires each have an improved flexural strength and excellent in hopping resistance.

If the blend amount of the halogen-free aromatic condensation phosphoric ester flame retardant is smaller than 5% (e.g., 4%), the flame resistance is not sufficient. If the blend amount is greater than 50%, the flame retardant is not properly mixed with the petroleum wax base. This is disadvantageous because the loudspeaker copper foil wire suffers from quality variations.

The loudspeaker copper foil wire according to this embodiment is an electrically conductive flexible wire including fiber threads and generally called “gold wire” or “cotton wire”. Whether the loudspeaker copper foil wire is called “gold wire” or “cotton wire” depending on the production method or the like, it is a matter of course that the copper foil wire falls within the scope of the present invention.

Where the present invention is applied to a surface treatment agent in any other fields requiring the moisture resistance, the corrosion resistance and the like, advantageous results can be provided. More specifically, where the present invention is applied to a wall sheet or a water-proof sheet, the moisture resistance and the corrosion resistance are expected to be improved without reduction of the flexibility.

### INDUSTRIAL APPLICABILITY

With the loudspeaker copper foil wire and the loudspeaker employing the copper foil wire according to the present invention, it is possible to ensure the flame resistance not lower than the UL Standard 94V-2 without reduction of the flexibility of the copper foil wire, while maintaining the effect of the wax. Further, the loudspeaker copper foil wire is excellent in moisture resistance and corrosion resistance, and useful for a loudspeaker required to withstand a greater input load.

1. A loudspeaker copper foil wire comprising a copper foil wire body impregnated or coated with a flame resistant wax, the flame resistant wax comprising a petroleum paraffin wax and 5 wt % to 50 wt % of a halogen-free aromatic condensation phosphoric ester flame retardant.

2. A loudspeaker copper foil wire as set forth in claim 1, wherein the halogen-free aromatic condensation phosphoric ester flame retardant has a melting point of 80° C. to 140° C. and a decomposition temperature of not lower than 250° C.

3. A loudspeaker copper foil wire as set forth in claim 1, wherein the copper foil wire body includes a plurality of core threads each wrapped with a copper foil and braided or stranded.

4. A loudspeaker comprising:
a magnetic circuit;
a frame mounted on the magnetic circuit;
a voice coil fitted in a magnetic gap of the magnetic circuit;
a vibration diaphragm having an inner rim connected to the voice coil and an outer rim connected to the frame;
an external connection terminal attached to the frame; and
a pair of copper foil wires connected to opposite ends of the voice coil at one-side ends thereof and connected to the external connection terminal at the other-side ends thereof;
wherein the copper foil wires each comprise the loudspeaker copper foil wire as recited in claim 1.
